(19) United States
(12) Patent Application Publication
(10) Pub. No.: US 2005/0045019 A1
(43) Pub. Date: Mar. 3, 2005

(54) Guitar Slide

(76) Inventor: Shaun Wright, Miami, FL (US)

Correspondence Address: THE LAW OFFICE OF ROBERT R. WARD, JR., ESQ., 8170 SW 93RD AVE, MIAMI, FL, 33173, US

(21) Appl. No.: 10/604,953

(22) Filed: Aug. 28, 2003

(51) Int. Cl. G10D 3/00

(52) U.S. Cl. 84/319

(57) ABSTRACT

A Slide for musical stringed instruments which includes a globular shaped body made of a material, such as glass, brass, or metal, designed to illicit specific sounds when placed in contact with a string of a musical instrument, a finger ring, and a means to connect the finger ring to the globular shaped body, such means allowing the finger to bend normally. A second embodiment has a tapered cylindrical form for the body.

### BACKGROUND OF INVENTION

Stringed instruments have enjoyed popularity with musicians and audiences alike for many years. As string instruments have grown in popularity the desire to make different sounds emanate from them has become important. Musicians have used glass bottles, socket wrenches and other things, which are “slid” along one or more strings of the instruments. These items will vibrate along the string and create a different sound than if the string was plucked with a finger. Each material provides for a different sound when used during the course of playing the instrument.

Musicians have used several different slides over the years. One widely accepted version is a cylindrical tube with open ends made from glass, brass or steel, which covers an entire finger of the musician. Several improvements over the simple tube have been made such as those shown in U.S. Pat. No. 5,251,527 to Roberts, issued on Oct. 12, 1993, where the inside of the tube is tapered to fit better on the finger of the musician.

This form of slide has several disadvantages in that it renders the finger over which it is worn as inflexible and unable to bend. When the musician wishes to resume normal play they must remove the slide, which can lead to issues with timing during play.

Other slides have attempted to address this issue by providing means to rotate them out of the way as such as those shown in U.S. Pat. No. 5,981,856 to Story, issued on Nov. 9, 1999, and in U.S. Pat. No. 5,492,046 to Jimenez, issued on Feb. 20, 1996. This manner of rotation still requires some dexterity on the part of the musician to move the slide out of the way while still maintaining the timing of play.

Further slides have allowed a musician to slide a single string with a single finger through the use of smaller cylindrical or semi-cylindrical slide shapes that may be attached in various ways to a single finger of the musician. Two examples of these are shown in U.S. Pat. No. 4,817,488, issued on Apr. 4, 1989 to de los Santos, and U.S. Pat. No. 5,515,762, issued on May 14, 1996 to Perkins, et. al. The slide from the '488 patent is attached at the mid-segment of a single player's finger leaving the end portion of the finger to play normally. Use of this slide is awkward and requires significant practice before mastering. The '762 patent disclosed a slide that is worn on the end of a single finger of the musician and has a cap that is used to make contact with a single string and apparently needs to be removed when playing the guitar normally.

Therefore a need exists for a musician to be able to slide across a single string or any combination of strings of a stringed musical instrument and be able to play the guitar normally without removing the slide.

The present invention addresses these shortcomings with a novel design that allows the slide to be worn permanently to generate desired musical effects, and yet allows for normal playing of a stringed musical instrument.

### SUMMARY OF INVENTION

Objectives of this invention include providing a fingering device that allows a user to slide one or more strings of a stringed musical instrument.

Another objective of the invention is to provide a slide that allows the user to contact a single string of the stringed musical instrument.

A further objective of the invention is to provide a slide that is made of glass, brass or steel.

Still another objective of the invention is to provide a plurality of slides that can contact as many or all of the strings of a stringed musical instrument as desired by the user.

A yet further objective of the invention is to allow the user to play a stringed musical instrument normally while wearing the invention.

These and other objectives and advantages of the invention are obtained by the improved slide of the present invention.

### BRIEF DESCRIPTION OF DRAWINGS

The accompanying drawings, which form part of the specification and are incorporate therein, illustrate several embodiments of the present invention but are in no way construed as limiting the invention. In the drawings:

FIG. 1 is a close up bottom view of a preferred embodiment of the present invention showing all components;

FIG. 2 is a side view of a preferred embodiment of the present invention showing all components;

FIG. 3 is a top view of a preferred embodiment of the present invention showing all components;

FIG. 4 is a side view of a preferred embodiment of the present invention showing all components while on a musician's forefinger; and

FIG. 5 is a bottom view of a preferred embodiment of the present invention while on a musician's forefinger.

FIG. 6 is a palm view of a preferred embodiment of the present invention with a slide present on each of the player's fingers of the left hand;

FIG. 7 is a side view of a preferred embodiment of the present invention while the player is engaging the slide in contact with a string;

FIG. 8 is a close up side view of a preferred embodiment of the present invention in contact with a string from a stringed instrument while the player is engaging the slide in contact with a string; and p FIG. 9 is a close up top (palm) view of a preferred embodiment of the present invention showing all components in contact with a string from a stringed instrument while the player is engaging the slide in contact with a string at sufficient pressure to play a normal note.

FIG. 10 is a close up bottom view of a second embodiment of the present invention showing all components;

FIG. 11 is a side view of a second embodiment of the present invention showing all components;

FIG. 12 is a top view of a second embodiment of the present invention showing all components;

FIG. 13 is a side view of a second embodiment of the present invention while on a musician's forefinger; and

FIG. 14 is a bottom view of a second embodiment of the present invention while on a musician's forefinger.

FIG. 15 is a palm view of a second embodiment of the present invention with a slide present on each of the player's fingers of the left hand;

FIG. 16 is a side view of a second embodiment of the present invention while the player is engaging the slide in contact with a string;

FIG. 17 is a close up side view of a second embodiment of the present invention n contact with a string from a stringed instrument while the player is engaging the slide in contact with a string; and

FIG. 18 is a close up top (palm) view of a second embodiment of the present invention in contact with a string from a stringed instrument while the player is engaging the slide in contact with a string at sufficient pressure to play a normal note.

### DETAILED DESCRIPTION

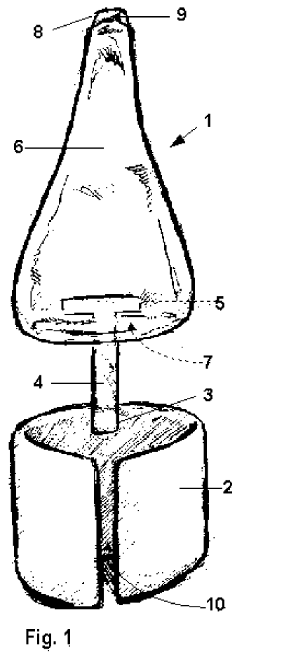

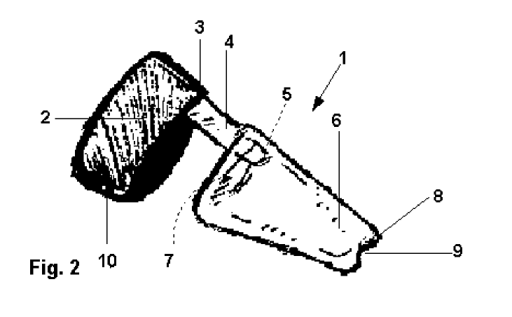

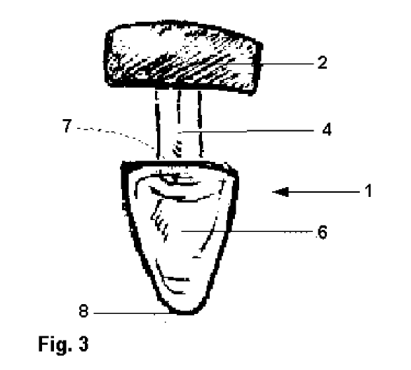

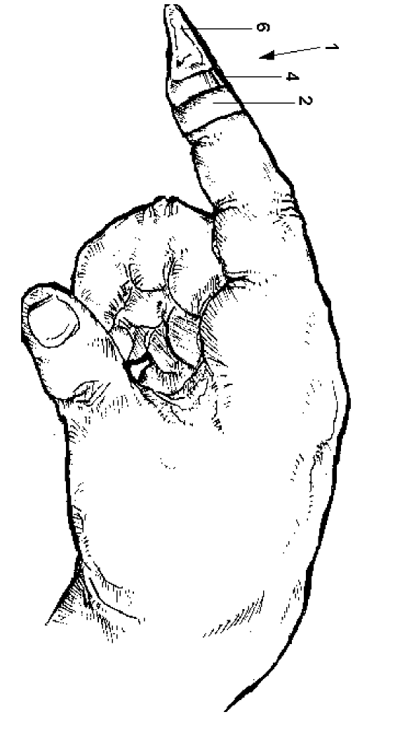

In a preferred embodiment, the guitar slide 1 generally as shown in FIGS. 1-9, comprises finger ring 2 preferably having gap 10 in the circumference for adjustability, joined at one end 3 preferably by soldering, welding or other permanent attachment to slide support connector 4. The slide support connector 4 is fashioned preferably in the shape of the letter “T.” The other end 5 of the slide support connector 4 is preferably embedded within the material used to form the body of the slide 6. The body of the slide 6 has a circular opening 7to receive the tip of a musician's finger and is generally shaped as a tapered cylinder down to a narrow tip 8. Preferably, a transverse shallow groove 9 of sufficient width and depth to cover the radial circumference of a guitar string is present at 8.

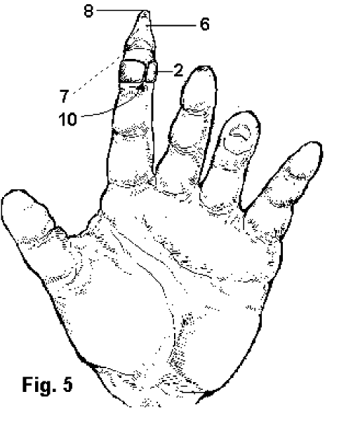

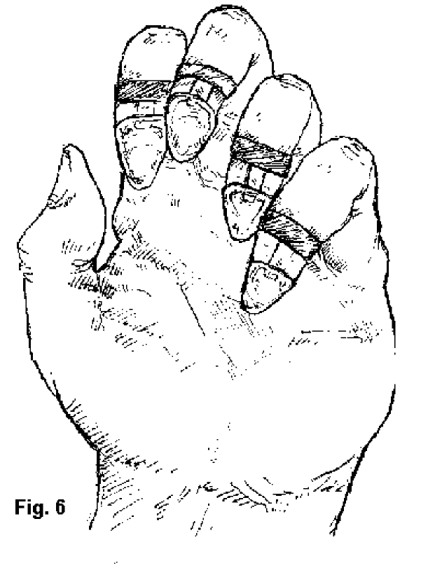

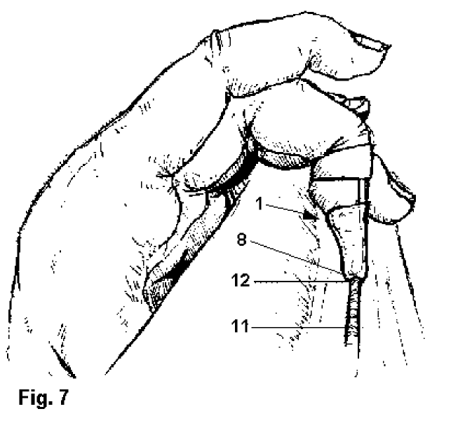

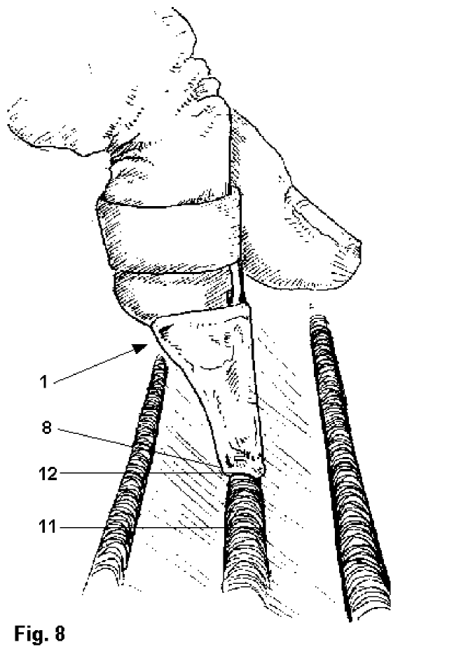

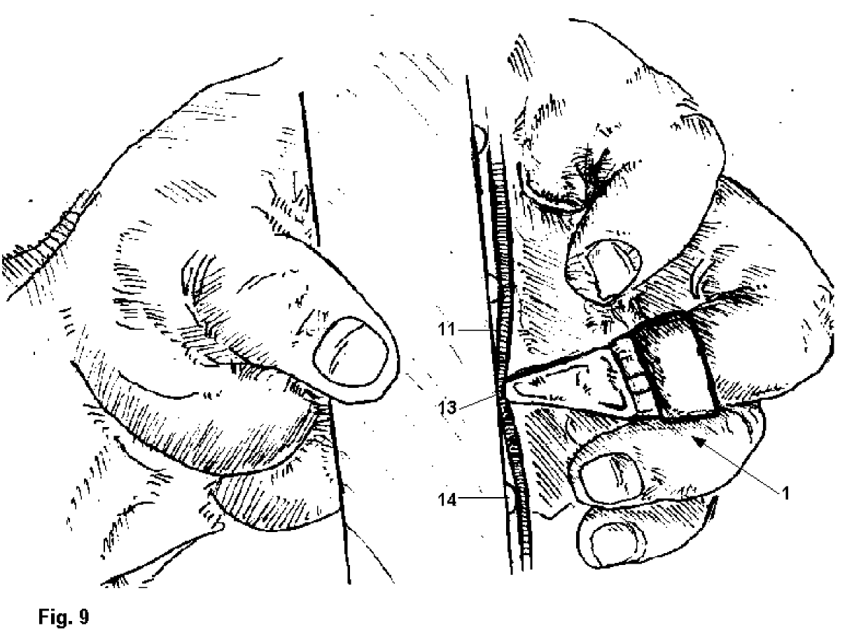

In operation, the guitar slide is worn on any finger desired by the musician. The finger tip is inserted through the finger ring 2 into opening 7 and the finger ring 2 is tightened, thereby reducing the gap 10 such that the slide fits snuggly around the base of the finger tip as shown in FIGS. 4 and 5. When the player wishes to play a slide note, or even chords when wearing multiple slides as shown in FIG. 6, the musician will align the slide above the string to be played at the point along the stringed musical instrument associated with the particular pitch of the note desired and press down sufficiently to change the sound as required as shown in FIG. 7 and FIG. 8. Further pressure will allow the player to play a normal note as the nearest fret will reduce the note normally and no slide sound will be heard as shown in FIG. 9.

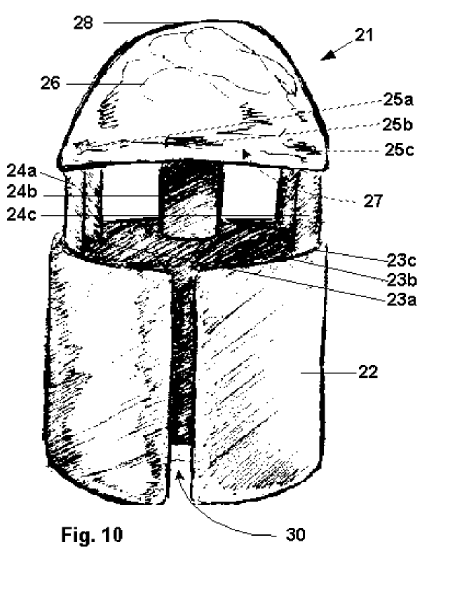

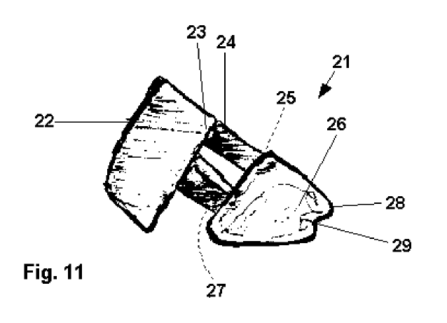

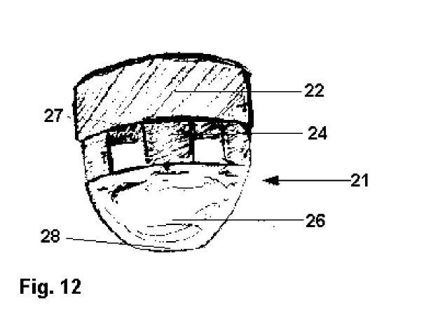

In accordance with a second embodiment of the invention, guitar slide 21 is show generally in FIGS. 10-18. In this embodiment, there are three slide support connectors 23a, 23b, and 23c as shown in FIGS. 10 and 11 specifically. Finger ring 22 with gap 30 connects at 24a, 24b, and 24c to the slide support connectors 16, 16a, and 16b respectively. Again, each of the other ends 25a, 25b, and 25c. of the slide support connectors 24a, 24b, and 24c, respectively, is embedded within the material used to form slide body 26. In this embodiment, slide body 26 has with a convex inner surface 27 to cover the tip of a musician's finger and a concave outer surface 28. Preferably, a transverse shallow groove 29 is present across the outer surface 28.

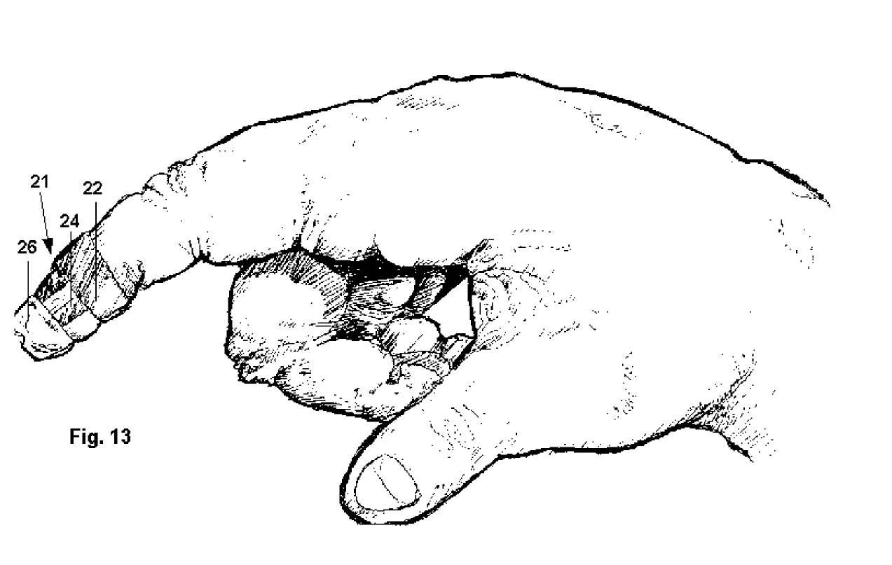

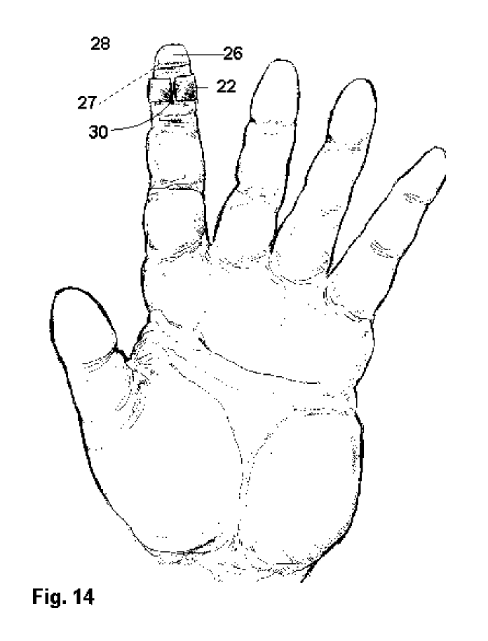

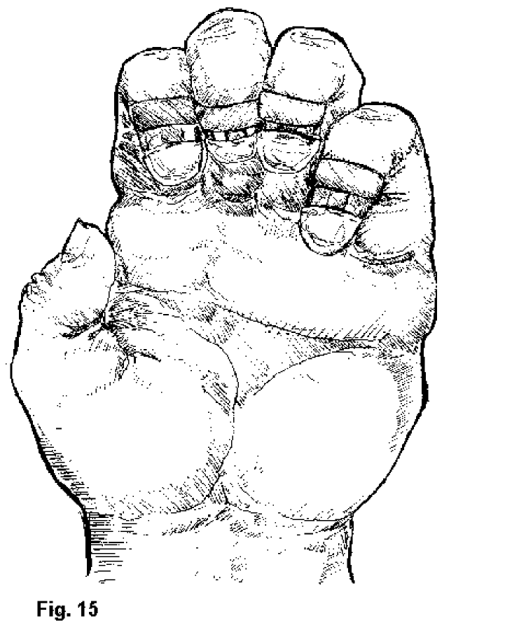

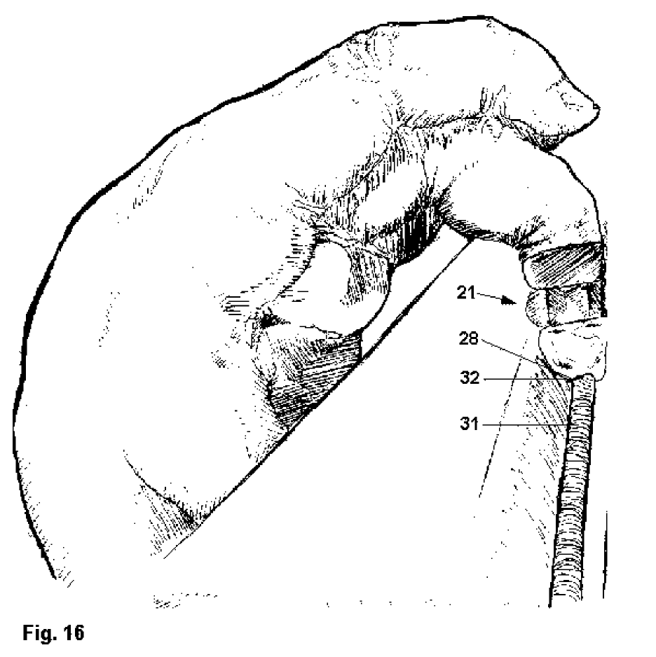

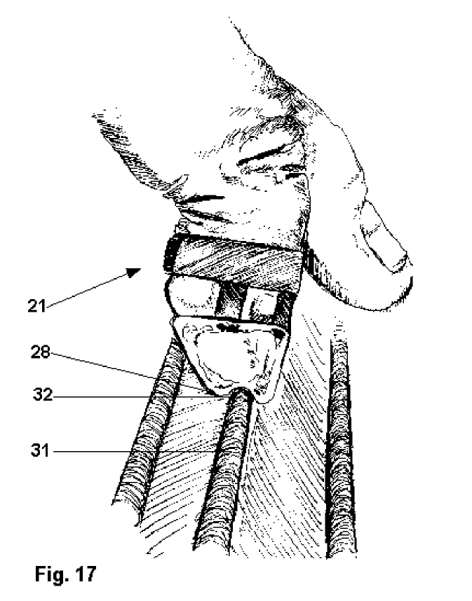

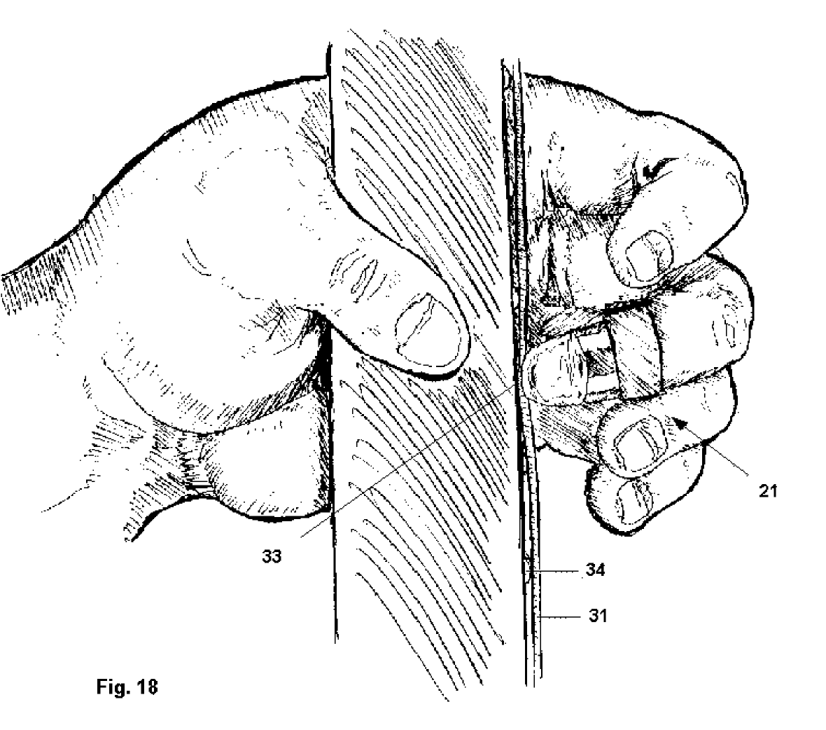

This embodiment is very similar in operation to the first embodiment's operation described above. The guitar slide is worn on any finger desired by the musician. The finger tip is inserted through the finger ring 22 into opening 27 and the finger ring 22 is tightened, thereby reducing the gap 30 such that the slide fits snuggly around the base of the finger tip as shown in FIGS. 13 and 14. When the player wishes to play a slide note, or even chords when wearing multiple slides as shown in FIG. 15, the musician will align the slide above the string to be played at the point along the stringed musical instrument associated with the particular pitch of the note desired and press down sufficiently to change the sound as required as shown in FIG. 16 and FIG. 17. Further pressure will allow the player to play a normal note as the nearest fret will reduce the note normally and no slide sound will be heard as shown in FIG. 18.

1. A slide apparatus for stringed musical instruments comprising
a. A globular shaped body made entirely from material designed to illicit specific sounds when placed in contact with one or more strings of a stringed musical instrument having a tapered inner surface means to receive a musician's finger, an inner end having a hole adapted to receive a musician's finger, a closed outer end, and an outer surface for contacting strings of a stringed musical instrument encompassing said closed outer end,
b. A finger ring; and
c. A means connecting the globular body to the finger ring allowing a musician's finger to bend normally.

2. A slide apparatus of claim 1 where a groove is present transversely across said outer surface to facilitate contact with a single string of a stringed musical instrument.

3. A slide apparatus for stringed instruments comprising
a. A tapered cylindrical shaped body made entirely from material designed to illicit specific sounds when placed in contact with one or more strings of a stringed musical instrument having a tapered inner surface means to receive a musician's finger, an inner end having a hole adapted to receive a musician's finger, a closed outer end extending beyond the musician's finger, and an outer surface for contacting strings of a stringed musical instrument encompassing said closed outer end,
b. A finger ring; and
c. A means connecting the cylindrical shaped body to the finger ring allowing a musician's finger to bend normally.

4. A slide apparatus of claim 3 where a groove is present transversely across said outer surface to facilitate contact with a single string of a stringed musical instrument.

5. A slide apparatus of claim 1 where the means to connect the finger ring and the globular body are at least two semi-rigid strips.

6. A slide apparatus of claim 2 where the means to connect the finger ring and the globular body are at least two semi-rigid strips.

7. A slide apparatus of claim 3 where the means to connect the finger ring and the globular body are at least two semi-rigid strips.

8. A slide apparatus of claim 4 where the means to connect the finger ring and the globular body are at least two semi-rigid strips.

9. A slide apparatus of claim 1 where the means to connect the finger ring and the globular body are three semi-rigid strips.

10. A slide apparatus of claim 2 where the means to connect the finger ring and the globular body are three semi-rigid strips.

11. A slide apparatus of claim 3 where the means to connect the finger ring and the globular body are three semi-rigid strips.

12. A slide apparatus of claim 4 where the means to connect the finger ring and the globular body are three semi-rigid strips.

13. A slide apparatus of claim 1 where the means to connect the finger ring and the globular body is a single semi-rigid strip.

14. A slide apparatus of claim 2 where the means to connect the finger ring and the globular body is a single semi-rigid strip.

15. A slide apparatus of claim 3 where the means to connect the finger ring and the globular body is a single semi-rigid strip.

16. A slide apparatus of claim 4 where the means to connect the finger ring and the globular body is a single semi-rigid strip.
